(19) United States
(12) Patent Application Publication
(10) Pub. No.: US 2013/0094079 A1
(43) Pub. Date: Apr. 18, 2013

(54) METHOD FOR PRODUCING LENTICULAR LENS, LENTICULAR LENS, OPTICAL ELEMENT AND THREE-DIMENSIONAL DISPLAY DEVICE

(71) Applicants: Koichi Fujishiro, Kisarazu-shi (JP); Toshihide Itahara, Kisarazu-shi (JP); Tohru Saito, Kisarazu-shi (JP); Takahiro Yoshioka, Kisarazu-shi (JP); Shinsuke Iguchi, Chigasaki-shi (JP); Kentaro Kumita, Sammu-shi (JP); Tomoharu Takita, Sammu-shi (JP)

(72) Inventors: Koichi Fujishiro, Kisarazu-shi (JP); Toshihide Itahara, Kisarazu-shi (JP); Tohru Saito, Kisarazu-shi (JP); Takahiro Yoshioka, Kisarazu-shi (JP); Shinsuke Iguchi, Chigasaki-shi (JP); Kentaro Kumita, Sammu-shi (JP); Tomoharu Takita, Sammu-shi (JP)

(21) Appl. No.: 13/701,762

(22) PCT Filed: Jun. 6, 2011
(86) PCT No.: PCT/JP2011/062940

§ 371 Date: Dec. 3, 2012

(30) Foreign Application Priority Data
Jun. 7, 2010 (JP) 2010-130018

(51) Int. Cl. B05D 5/06; G02B 27/22; G02B 3/00

(52) U.S. Cl. CPC B05D 5/06; G02B 3/005; G02B 27/2214
USPC 359/463; 359/619; 427/508

(57) ABSTRACT

Provided is a method for manufacturing a lenticular lens sheet to be used in a stereoscopic display, a projection screen, and the like without using a mold at low cost. A method of manufacturing a lenticular lens sheet, the lenticular lens sheet including a support substrate and a plurality of lenticular lenses formed on the support substrate, includes the steps of: (1) filling a transparent resin composition ink containing an ultraviolet-curable component of 90 wt % or more and having surface ink-repellency after curing with ultraviolet light to a lens area of an even-numbered array by an inkjet method; (2) curing the transparent resin composition ink obtained in the step (1) with ultraviolet light; (3) filling a transparent resin composition ink containing the ultraviolet-curable component of 90 wt % or more and being curable with ultraviolet light to a lens area of an odd-numbered array by an inkjet method; and (4) forming the plurality of lenticular lenses in the lens areas of the even-numbered array and the odd-numbered array by curing the transparent resin composition ink obtained in the step (1) and the transparent resin composition ink obtained in the step (3) with ultraviolet light.

### TECHNICAL FIELD

The present invention relates to a method of manufacturing a lenticular lens sheet by using an inkjet printing method and a lenticular lens obtained by the method, and further relates to an optical element and a stereoscopic display formed by using the lenticular lens.

### BACKGROUND ART

Lenticular lens sheets are elements to be used in a back-light unit of a liquid crystal display, a rear-projection display, a projection screen, a stereoscopic display, and the like. In general, a concave lens is formed like a stripe on a surface of a transparent substrate such as glass or a plastic sheet.

In particular, a three-dimensional display is known as one of the display systems which have attracted attention as next-generation display systems. Among modes of the three-dimensional display, as one which does not require any special glasses, a lenticular mode is typically given (see Non Patent Literature 1). Various three-dimensional displays of such mode in combination with a flat panel display such as a liquid crystal display (LCD) have recently been proposed, and thus the mode is considered to be closest to a practical level. However, in the conventional lenticular mode, an image resolution depends on a pitch of a lens or a barrier. Hence, a lens having a higher definition is required for realizing a display having a higher resolution. Further, it is necessary to position a lens and a barrier accurately with respect to a flat panel display.

Meanwhile, a three-dimensional display using a field-sequential light direction control back light has recently been proposed as a novel mode of the three-dimensional display (see Patent Literature 1). A principle of this mode involves adopting, as a back light of a display, a field-sequential light direction control back light 1 which can change a direction of light (LD) from the back light sequentially at high speed, and displaying an image depending on the direction of the light on a transmission display 2. Through utilization of this mode, binocular parallax images are provided in directions of left and right eyes LE and RE, and the directions are switched at blinding speed, thereby being able to provide a three-dimensional image to an observer. Further, an image resolution of this mode is the same as that of an LCD, and hence a high resolution of the LCD can be directly utilized, which facilitates manufacture and an increase in resolution.

In general, the lenticular lens has a spherical surface profile, and the following methods are known as processing means therefor. That is, for example, there are given: (1) a method of subjecting a molten or semi-molten thermoplastic resin to injection molding; (2) a method of subjecting a sheet to embossing under heating (see Patent Literature 2); (3) a method of curing an ultraviolet curable resin in a template with ultraviolet light (see Patent Literature 3) ; and (4) a method of subjecting an ultraviolet curable resin to screen printing, and curing the ultraviolet curable resin with ultraviolet light (see Patent Literature 4). However, any of these manufacturing methods requires a mold having high processing accuracy or requires a printing plate. Further, the mold or the plate inevitably comes into contact with a lens surface, and hence a foreign matter is mixed into a lens, or a flaw in the mold easily affects the lens.

Meanwhile, as a method of manufacturing a color filter by using an inkjet method, there is known a pixel forming method of ejecting and curing inks of red, blue, and green only on required pixels, respectively, in a simultaneous manner, in which a partition is formed in advance in a photolithography process and the ink is ejected on a pixel portion defined by the partition. In this method, in order to avoid blurring of each color area and color mixing between adjacent areas, for example, an example is disclosed in Patent Literature 5 in which the color mixing can be avoided so long as a static contact angle between the ink and the partition surface is 30° to 55°. A height of the ink filled by using the inkjet method at this time with respect to a height of the partition is as high as about 4 times to 6 times.

As means for providing the partition to achieve such an object, the following two methods have been proposed. That is, (1) a treatment of a surface layer of the partition by using a fluorine-containing plasma gas (see Patent Literature 6) and (2) a method of mixing a fluorine-based compound or a silicon-based compound in a composition of a photoresist as a component for providing ink-repellency (see Patent Literature 5).

However, as for the manufacture of the color filter by using the inkjet method, although a resolution and a precision at a liquid crystal display device (LCD) level has already been established so far, there has been no attempt to manufacture a lenticular lens by using the inkjet method to the best of the inventors' knowledge despite the fact that a formation of a spherical dot lens by using the inkjet method is observed in some examples (see Patent Literature 7).

### CITATION LIST

### Patent Literature

[PTL 1] JP 2004-20684 A
[PTL 2] JP 09-114024 A
[PTL 3] JP 2002-365405 A
[PTL 4] JP 2000-155380 A
[PTL 5] JP 11-281815 A
[PTL 6] JP 06-65408 A
[PTL 7] JP 2005-249882 A

### Non Patent Literature

[NPL 1] Takanori Okoshi, “Three-dimensional imaging techniques,” Asakura Publishing Co., Ltd. (1991)

### SUMMARY OF INVENTION

### Technical Problem

The present invention has been made in view of the conventional problems in the manufacture of the lenticular lens, and an object of the present invention is to solve problems that the conventional molding method, which uses a mold and a plate, has decreased a yield due to mixing of a foreign matter and a flaw in a mold or the like, failing to prevent a lens surface from being brought into contact, and has not been suitable for manufacturing inexpensive and various kinds of lenticular lenses due to a usage of an expensive mold.

### Solution to Problem

The inventors of the present invention have recognized that formation of the lenticular lens by using the inkjet method is a non-contact printing method that does not need a mold and a printing plate, and completed the present invention from a finding that a sufficient precision up to LCD level can be achieved.

That is, an outline of the present invention is as follows.

A method of manufacturing a lenticular lens sheet, the lenticular lens sheet including a support substrate and a plurality of lenticular lenses formed on the support substrate, the method including the steps of:

(1) filling a transparent resin composition ink containing an ultraviolet-curable component of 90 wt % or more and having a surface ink-repellency after curing with ultraviolet light to a lens area of an even-numbered array including an nth array, an (n+2)th array, and an (n+4)th array by an inkjet method;

(2) curing the transparent resin composition ink obtained in the step (1) with ultraviolet light (see section (A) of FIG. 1);

(3) filling a transparent resin composition ink containing the ultraviolet-curable component of 90 wt % or more and being curable with ultraviolet light to a lens area of an odd-numbered array including an (n+1)th array, an (n+3)th array, and an (n+5)th array by an inkjet method (see section (B) of FIG. 1); and

(4) forming the plurality of lenticular lenses in the lens areas of the even-numbered array and the odd-numbered array by curing the transparent resin composition ink obtained in the step (1) and the transparent resin composition ink obtained in the step (3) with ultraviolet light (see section (C) of FIG. 1).

Note that, n represents a natural number.

As the ultraviolet-curable transparent resin composition ink to be filled by the inkjet method, it is preferred to use an ink having a liquid-phase composition and including an optical initiator whose main component is a liquid-phase multifunctional acryl in both the step (1) and the step (2). The inks are prepared to have a viscosity of 5 mP·sec to 40 mP·sec and a surface tension of 20 mN/m to 35 mN/m at a head temperature of 20° C. to 45° C. such that the inks are ejected in a stable manner by the inkjet method. Because the ink jetted on the support substrate is in a liquid phase, the ink is maintained in a spherical shape with a static contact angle θ_{L} due to its surface tension and an interfacial tension between the ink and the substrate. Further, in order to maintain the spherical shape with good reproducibility, the ink contains an ultraviolet-curable component of 90 wt % or more (in this case, the total amount of the ultraviolet-curing resin and the optical initiator). In particular, in order to maintain the spherical shape, it is not preferred that a component that is volatilized before the UV curing exceed 10 wt %. In addition, because the volume of the ink is shrunk due to the curing with ultraviolet light or a heat treatment after the curing, in order to obtain a target lens height and a target lens shape, it is preferred to irradiate the ink with ultraviolet light such that a residual volume ratio becomes 70 vol % or more, preferably, 75 vol % or more. If the residual volume ratio is below 70 vol %, a fluctuation within the plane of the lenticular lens sheet may become conspicuous or a wrinkle may be generated on the surface.

As required in the step (1), means for providing ink-repellency after the curing with ultraviolet light mixes a fluorine-based compound or a silicon-based compound, which are soluble in the liquid-phase multifunctional acryl, in the ink in advance. In particular, it is preferred to use a (meth)acrylic acid copolymer that contains fluorine-containing (meth)acrylic acid ester unit. A known material can be used as the (meth)acrylic acid ester to be copolymerized.

The above-mentioned basic components are mixed, and a surface tension adjuster and a reactive diluent for achieving a low viscosity are further mixed to obtain a characteristic value suitable for a continuous ejecting property as an ink for the inkjet application. A normally-used inkjet head employs a piezoelectric element. For example, the surface tension is 20 mN/m to 40 mN/m such that the viscosity becomes 5 mP·sec to 30 mP·sec at the head temperature of 20° C. to 45° C.

In order to manufacture a uniform lenticular lens sheet, it is desired to perform a surface treatment of the transparent support substrate, and then make uniform contact angles of the transparent resin composition ink used in both the step (1) and the step (2) with respect to the support substrate. It is because the ink jetted on the support substrate is in a liquid phase, and the width and the contact angle of the ink are determined by maintaining an optimal spherical shape for a lens shape by the surface tension of the ink. When a desired lenticular lens shape obtained after the curing is defined by the width w₀ (μm), the height h₀ (μm), and the contact angle θ₀ (°) with respect to the support substrate, it is preferred that the contact angle θ_{L} between the transparent resin composition ink and the transparent support substrate be equal to or larger than η₀ and equal to or smaller than 30°, more preferably equal to or larger than θₒ and equal to or smaller than 25° (section (a) of FIG. 2). If θ_{L} is equal to or smaller than θ₀, the desired lens contact angle may not be obtained due to the shrinkage caused by curing thereafter. Further, if θ_{L} exceeds 30°, a bulge is likely to be generated at the time of inkjet drawing, which is not desired in terms of the linearity. It is preferred that θ_{L} be equal to or larger than 3°, which is suitable for suppressing a fluctuation of the height due to wet spreading after being jetted at this time. The angle θ₀ is an angle between the surface of the lenticular lens and the support substrate, and as illustrated in section (b) of FIG. 2, it refers to a rise angle of the lens after being cured with respect to the support substrate.

Although a surface treatment method for the support substrate depends on a type of the support substrate, known means can be used. For example, the surface treatment method includes an atmospheric-pressure plasma method, a corona discharge, an ultraviolet treatment, pre-coating of a fluorine-based ink-repellent agent, a treatment using a silane coupling agent, and the like.

A filling amount of the transparent resin composition ink used in both the step (1) and the step (2) is set by the following (Equation 1). That is, the filling amount is adjusted by an amount of one droplet, the number of droplets filled per unit length, a droplet dotting pitch, and the like such that a filling amount V of the ink per unit length (pl/μm) in the longitudinal direction required to obtain the lenticular lens becomes larger than a volume amount V₀ per unit length (pl/μm) in the longitudinal direction of the lenticular lens, considering the shrinkage caused by curing thereafter. In (Equation 1), r represents a curvature radius of a cross section of the lens.

$${θ}_{0} = 2 \times {tan}^{- 1} [ \frac{{h}_{0}}{( \frac{{w}_{0}}{2} )} ] \\ {h}_{0} ( r ) = \sqrt{\frac{{( \frac{{w}_{0}}{2} )}^{2}}{{sin}^{2} {θ}_{0}} - {r}^{2}} - \frac{\frac{{w}_{0}}{2}}{tan {θ}_{0}} \\ {V}_{0} = {\int }_{- \frac{w 0}{2}}^{\frac{w 0}{2}} {h}_{0} ( r ) d r ( pl / μ m ) \qquad ( Equation 1 )$$

At this time, following the inkjet filling, a contact line of the ink and the support substrate is fixed by performing ultraviolet irradiation on the transparent resin composition ink on the same filling stage. A width of the lenticular lens is controlled in an easy manner, and a satisfactory result is obtained in the linearity of the lenticular lens. An amount of the ultraviolet exposure at that time is, although it depends on the ink sensitivity, preferably 20 mJ/cm² to 500 mJ/cm², more preferably 30 mJ/cm² to 200 mJ/cm². Specifically, a procedure for producing a lenticular lens sheet having a continuous shape with the same lenticular lens pitch w₀, lens height h₀, and lens width w₀ of the even-numbered array and the odd-numbered array is described below. The width when the printing contact line is fixed by the ultraviolet irradiation after drawing the even-numbered array is set to the lens pitch w₀, and known inkjet filling conditions such as the amount of one droplet ejected from an inkjet nozzle, the ejecting period, the dotting pitch, and the nozzle interval are adjusted such that the printing pitch between the nth lenticular lens and the (n+2)th lenticular lens in the even-numbered array of the lens area is equal to two times the intended lenticular lens pitch w₀. At this time, the filling amount V of the ink per unit length (pl/μm) required to obtain the lenticular lens is adjusted to be larger than the volume amount V₀ per unit length (pl/μm) of the lenticular lens, which is represented by (Equation 1), considering the shrinkage caused by curing thereafter.

Subsequently, an ink having at least the same reactive component as the transparent resin composition ink, preferably the same resin composition ink is filled by the inkjet method between the even-numbered array lenticular lenses, such as between the nth lenticular lens and the (n+2)th lenticular lens formed in the above-mentioned manner, that is, an area corresponding to the odd-numbered array such as an (n+1)th array. However, at this time, there is further applied an amount of the ultraviolet exposure such that the nth lenticular lens and the (n+2)th lenticular lens formed in the prior stage are not dipped by the ink corresponding to the (n+1)th array.

In addition, because the lenticular lens of the even-numbered array such as the nth array and the (n+2)th array is applied with the surface ink-repellency at least after the step (2), the transparent resin composition ink of the odd-numbered array such as the (n+1)th array is not formed in an overlapping manner. In order to avoid this overlapping, the surfaces of the nth lenticular lens and the (n+2)th lenticular lens may be formed such that the static contact angle of the transparent resin composition ink used in the step (3) becomes equal to or larger than 35°, preferably equal to or larger than 40°. In order to confirm this static contact angle, θₖ set in the following pre-test may be set to be equal to or larger than 35°, preferably equal to or larger than 40°. The exposure with ultraviolet light can be performed by using a known ultraviolet exposure machine following the inkjet filling device, and in order to perform curing in a succeeding manner on the inkjet stage, it suffices to use an LED-UV lamp having a high exposure intensity. The amount of the ultraviolet exposure required to this process is preferably equal to or larger than 1,000 mJ/cm². The angle θₖ in the pre-test is a contact angle measured 1 second after filling the transparent resin composition ink used in the step (1) with a thickness of 2 μm to 5 μm on a separate glass substrate, curing the ink under the same condition as that of the step (2), creating a semi-cured coating substrate, and dropping the transparent resin composition ink used in the step (3) with an amount of 0.5 μl on this semi-cured coating substrate (FIG. 3)

The lenticular lens sheet formed in the even-numbered array and the odd-numbered array in the above-mentioned manner may be further irradiated with sufficient ultraviolet light. In recent years, a compact high-illuminance exposure machine using a UV-LED lamp is commercially available (for example, from OMRON CORPORATION and NICHIA CORPORATION), and such an exposure machine can be used. Although it is preferred that the required amount of exposure be equal to or larger than 1,000 mJ/cm², because the amount also depends on the type of the transparent resin composition ink and the exposure machine illuminance/output wavelength, in general, it is preferred that the amount of exposure be equal to or larger than an amount of exposure with which a residual volume ratio dependency of the amount of exposure is decreased. In addition, if a heat treatment at 80° C. to 140° C. is applied after the curing with ultraviolet light, a satisfactory result is obtained in the durability of the lenticular lens sheet. Only with an optical radical polymerization, in the ultraviolet-curable resin composition, virtually no reaction of double bonding is completed, so that an unreacted acrylic monomer often remains. In addition, a residual stress remains due to a shrinkage caused by the optical curing, which causes a phenomenon that the lens characteristic and the adhesiveness are changed with time. By reducing the residual monomer and the residual stress by the heat treatment, the durability of the lens characteristic is improved.

A general transparent substrate used for a lenticular lens can be used as a support substrate used when the lenticular lens sheet is obtained. Glass for a liquid crystal display as well as a transparent plastic sheet or film having a transmissivity of 90% or higher, such as acryl, PET, PC, and polyolefin, can be used.

### Advantageous Effects of Invention

According to the present invention, by forming the lens area of the even-numbered array and the lens area of the odd-numbered array in separate steps by using the inkjet method, the lenticular lens sheet can be obtained without using a mold and a plate, unlike the conventional method, and therefore, there is no possibility of decreasing the yield due to mixing of a foreign matter, a flaw in a mold, and the like. In addition, because no mold and plate are used, it is suitable for obtaining various types of lenticular lens sheets with arbitrary sizes. Further, the obtained lenticular lens sheet can be suitably used in an optical element for capturing or displaying a three-dimensional image in combination with a liquid crystal element, a projector element, and an imaging element, in a stereoscopic display, in a rear projection display, and in a projection screen.

### BRIEF DESCRIPTION OF DRAWINGS

FIG. 1 is a schematic diagram illustrating a process of manufacturing a lenticular lens sheet according to the present invention.

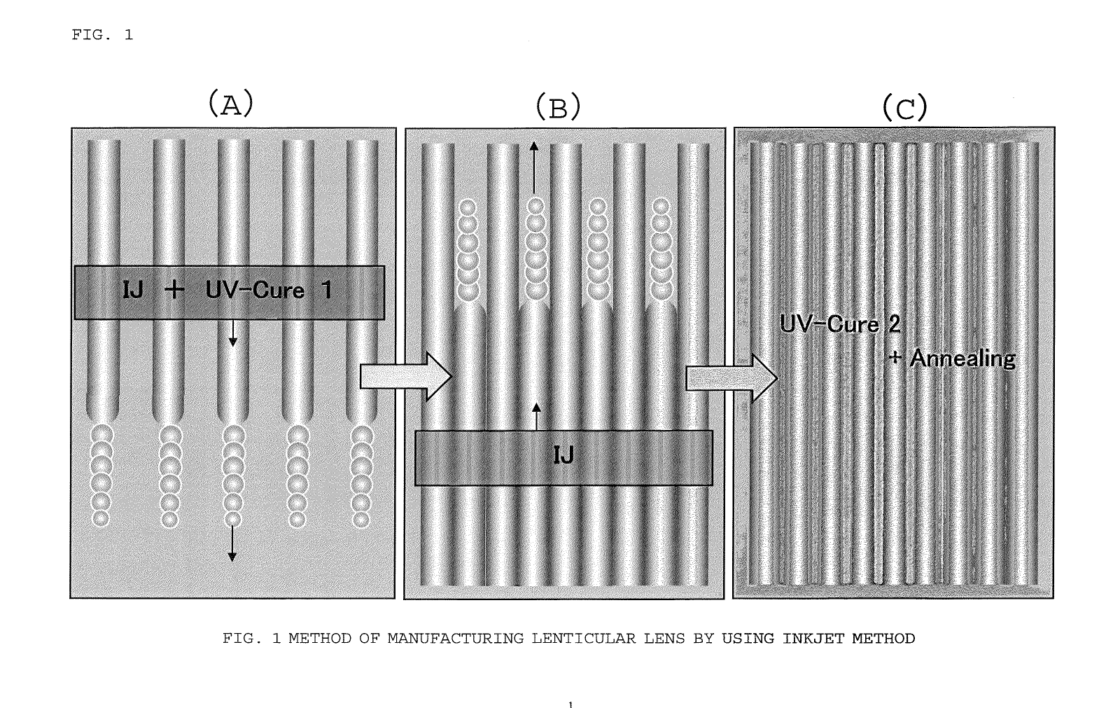

FIG. 2 is a schematic diagram illustrating a contact angle θ_{L} of a transparent resin composition ink with respect to a support substrate and an angle θ₀ of a surface of a lenticular lens with respect to the support substrate.

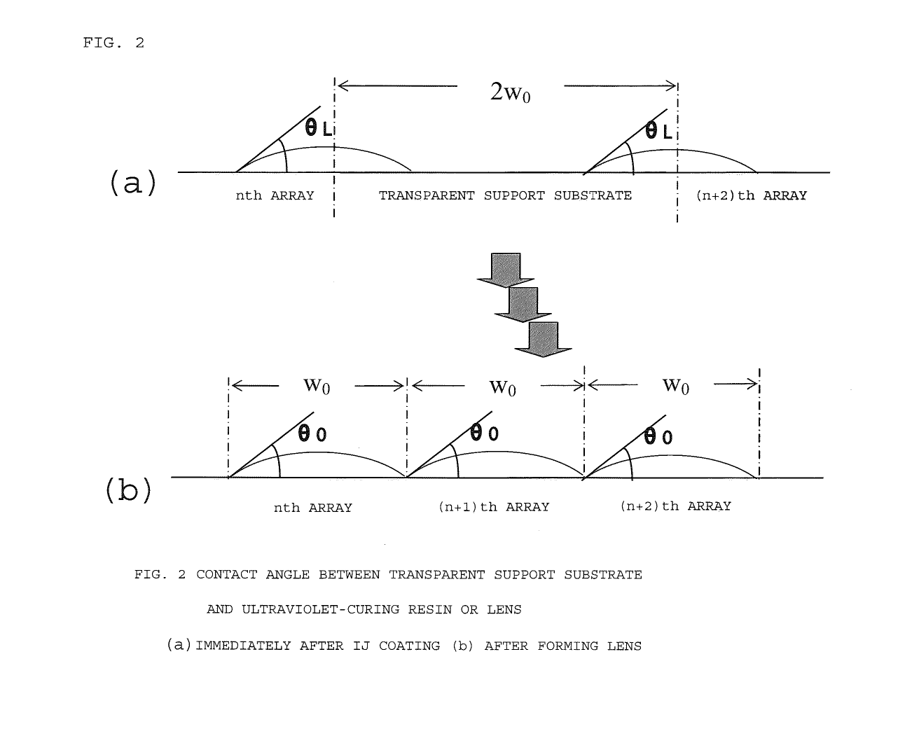

FIG. 3 is a schematic diagram illustrating a pre-test for obtaining a static contact angle of the transparent resin composition ink used in step (3) with respect to a coating surface after ultraviolet curing in step (2).

FIG. 4 is a SEM image of a cross section of the lenticular lens sheet obtained in an example.

FIGS. 5 are schematic diagrams illustrating the lenticular lens.

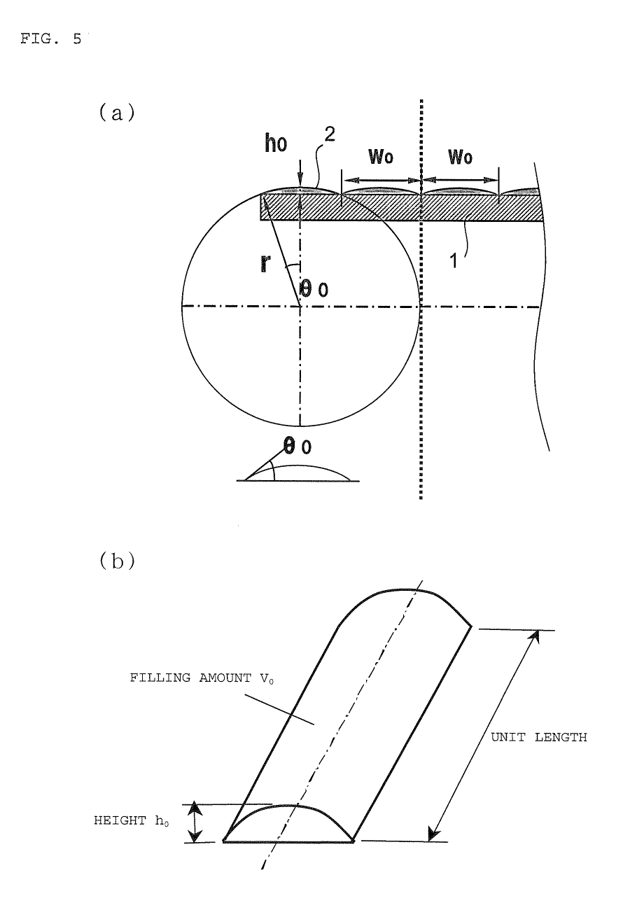

### DESCRIPTION OF EMBODIMENTS

Next, the present invention is described in detail by way of examples. Note that, each of the terms “part(s)” in the following description means “part(s) by mass.”

### EXAMPLES

[Preparation of Ultraviolet Curable Resin Ink (A1)]

15 parts of phenylethyl methacrylate-terminated polydivinylbenzene (PDV) (manufactured by NIPPON STEEL CHEMICAL CO., LTD.), 5 parts of trimethylolpropane triacrylate, 10 parts of 2-hydroxyethyl acrylate, 50 parts of 1,4-butanediol diacrylate, 20 parts of 1,9-nonanediol diacrylate, 30 parts of Irgacure 184 (manufactured by Ciba Specialty Chemicals Inc.), 0.05 part of ADK STAB AO-60 (manufactured by ADEKA CORPORATION), and 1.1 parts of a diethylene glycol monoethyl ether acetate solution containing 10% of a surfactant BYK 378 (manufactured by BYK-Chemie Japan K.K.) were mixed and further, 0.5 part of a fluorine-containing acrylic oligomer (manufactured by DAIKIN INDUSTRIES LTD.) was added to form a homogeneous solution. The solution was filtered through a 0.2-μm microfilter to prepare an ultraviolet curable resin ink A1. The ink had a viscosity of 33 mPa·sec (23° C.), a surface tension of 25.1 mN/m (23° C.), and a density of 1,060 kg/m³.

### Example 1

A 5-inch alkali-free glass AN-100 (manufactured by ASAHI GLASS CO., LTD.) was used and subjected to a deep UV treatment for 1 minute in advance (substrate I-1). The wettability of a surface of the substrate was measured with the ink A1 obtained in the foregoing. As a result, its contact angle was found to be σ_{L}=9.1°. In this case, conditions for the measurement of the contact angle were as follows: 0.5 μl of the ink A1 was dropped onto the alkali-free glass AN-100 to measure a contact angle 1 second after the dropping (measurement temperature: 23° C.) through use of OCH200 manufactured by Data Physics Corporation.

[Production of Lenticular Lens Sheet]

A10-minute continuous ejection test on the ultraviolet curable resin ink (A1) obtained at a head temperature of 35° C. in the foregoing was performed by using an inkjet head (KM512L, specification: 42 pl) manufactured by Konica Minolta Holdings, Inc. at a driving frequency of 4.8 kHz and an applied voltage of 17.84 V. The ink did not cause any nozzle clogging and exhibited a satisfactory ejection characteristic.

Next, as a target lenticular lens sheet, a lens pitch w₀, a lens height h₀, and a lens contact angle θ₀ were set to 135 μm, 4.82 μm, and 8.2°, respectively, and the substrate I-1 was used to produce a lenticular lens sheet. KM512L was used as an inkjet head, and the UV-LED in-line exposure head was mounted 50 mm behind the inkjet head. Drawing was performed at a stage speed of 125 mm/sec and a dot pitch of 75 μm/drop through use of one nozzle of KM512L, and UV-LED in-line exposure was performed on a stage immediately after the drawing. A cumulative amount of exposure at this time was 40 mJ/cm². A state and profile immediately after the in-line exposure were measured through use of an optical microscope and an optical interference surface profiler WYCO NT 1100 (manufactured by Veeco Japan), respectively. As a result, a line satisfactory in linearity and having a width w of 135 μm, a height h of 5.4 μm, and a contact angle of 9.1° was found to be formed. Further, with respect to the obtained straight line of the lenticular lens, lines were drawn in the same manner with an interval of 270 μm to create the total of 10 lenticular lenses (with a repetition pitch of 270 μm)

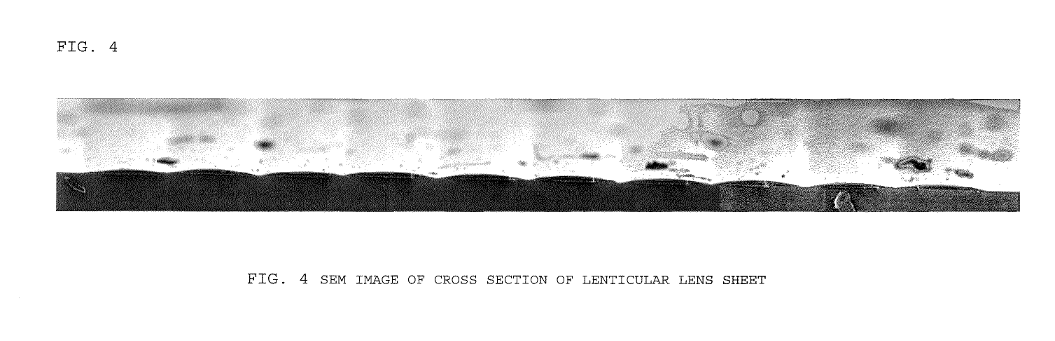

Subsequently, exposure was performed at 3,000 mJ/cm² with a one-shot exposure machine (manufactured by Japan Science Engineering Co., Ltd., illuminance of 50 mW/cm²). The ultraviolet curable resin ink A1 was drawn with one nozzle by using the KM512L in the same manner as described above with respect to an area between adjacent lines of the obtained 10 lines, and the UV-LED inline exposure was performed in a succeeding manner. Microscopic observation immediately after the exposure showed a satisfactory linearity without overlapping of the boundaries of the nth array and the (n+1)th array. Exposure was further performed at 7,000 mJ with the one-shot exposure machine (illuminance of 50 mJ/cm²), and a heat treatment was performed at 80° C. for 15 minutes. The surface profile showed a smooth spherical surface even after the exposure at 7,000 mJ and the heat treatment, and it was confirmed by SEM observation that a continuous lenticular lens shape was obtained without overlapping with each other (see FIG. 4). It was also confirmed that the width w did not change from 135 μm even after the exposure and the heat treatment, and the line had a height h of 4.83 μm±0.1 and a contact angle of 8.2° even after the exposure and the heat treatment, and showed a target profile.

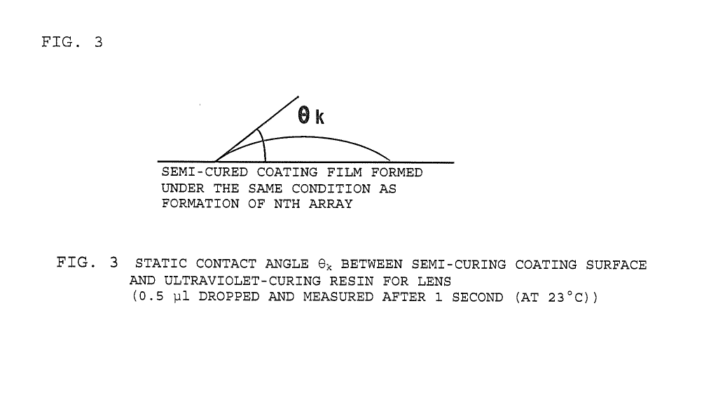

For the purpose of measuring θₖ (see FIG. 3), the ink A1 was subjected to spin-coating on a 5-inch glass substrate, and exposure was performed at 3,000 mJ with the one-shot exposure machine (illuminance of 50 mJ/cm²), to create a transparent coating substrate. Measuring the static contact angle (at 23° C.) after dropping the ink A1 of 0.5 μl on this substrate confirmed that the static contact angle was 50°.

### Example 2

It was prepared such that the dotting pitch between the inkjet nozzles became 67.75 μm by tilting the inkjet head KM512L with respect to the stage scanning direction. Further, the UV-LED inline exposure head was mounted 50 mm behind the inkjet head. The substrate I-1 was fixed to the stage, and six nozzles were opened for every three nozzle openings (pitch of 270 μm). Six lines were drawn at the stage speed of 125 mm/sec such that an eject dotting pitch of one nozzle became 75 μm, and exposure was performed at the same time. Microscopic observation of the state immediately after the drawing confirmed that the six lines were formed with a satisfactory linearity.

The ink A1 was drawn between respective adjacent lines of the six lines in the same manner, and exposure was performed at the same time. Further, exposure was performed at 7,000 mJ with the one-shot exposure machine (illuminance of 50 mJ/cm²), and a heat treatment was further performed at 80° C. for 15 minutes. The smooth spherical surface was maintained even after the heat treatment, and it was confirmed that a lenticular lens of a target profile was obtained without overlapping with each other with a width w of 135 μm, a height h of 4.81 μm, and a contact angle of 8.2°.

### Example 3

In the same manner as Example 1 except for an amount of the final exposure set to 2,000 mJ/cm², a lenticular lens sheet was produced. It was confirmed by SEM observation that the surface profile showed a smooth spherical surface even after the exposure and the heat treatment. It was also confirmed that the width w did not change from 135 μm even after the exposure and the heat treatment, and the line had a height h of 4.83 μm±0.1 and a contact angle of 8.2° even after the exposure and the heat treatment, and showed a target profile.

### Comparative Example 1

By using an ink obtained by removing a fluorine-containing acrylic oligomer from the ink A1, the lenticular lens sheet was attempted to be produced in the same manner as Example 2. However, the (n+1)th array filled later was combined with the nth array and the (n+2)th array, resulting in an improper lens shape.

When the static contact angle θₖ of the ink A1 on a transparent coating substrate was measured after creating the transparent coating substrate in the same manner as Example 1, the static contact angle was 19°.

### Comparative Example 2

By using the ink A1 and the substrate I-1, the total of 10 lenticular lenses (width of 135 μm) was drawn in the same manner as Example 1 with an interval of 270 μm, and exposure was performed at 300 mJ/cm² with the one-shot exposure machine (manufactured by Japan Science Engineering Co., Ltd., illuminance of 50 mW/cm²). Subsequently, the ink A1 was filled between the lenses in the same manner as Example 1, and the boundaries were observed with a polarizing microscope. A swollen disturbed linearity was observed at a part of the boundaries.

### REFERENCE SIGNS LIST

1: support substrate
2: lenticular lens

1. A method of manufacturing a lenticular lens sheet,
the lenticular lens sheet comprising a support substrate and a plurality of lenticular lenses formed on the support substrate,
the method comprising the steps of:
(1) filling a transparent resin composition ink containing an ultraviolet-curable component of 90 wt % or more and having surface ink-repellency after curing with ultraviolet light to a lens area of an even-numbered array including an nth array, an (n+2)th array, and an (n+4)th array by an inkjet method;
(2) curing the transparent resin composition ink obtained in the step (1) with ultraviolet light;
(3) filling a transparent resin composition ink containing the ultraviolet-curable component of 90 wt % or more and being curable with ultraviolet light to a lens area of an odd-numbered array including an (n+1)th array, an (n+3)th array, and an (n+5)th array by an inkjet method; and
(4) forming the plurality of lenticular lenses in the lens areas of the even-numbered array and the odd-numbered array by curing the transparent resin composition ink obtained in the step (1) and the transparent resin composition ink obtained in the step (3) With ultraviolet light.

2. A method of manufacturing a lenticular lens sheet according to claim wherein a static contact angle of the transparent resin composition ink obtained in the step (3) with respect to a coating surface after the curing with ultraviolet light in the step (2) is equal to or larger than 35°.

3. A method of manufacturing a lenticular lens according to claim 1, wherein before filling the transparent resin composition ink obtained in the step (1) and the transparent resin composition ink obtained in the step (2), at least cleaning, or surface treatment is performed on the support substrate to make a contact angle σ_{L} between the transparent resin composition ink and the support substrate satisfy the following relationship:
θ₀≦θ_{L}≦30°
where θ₀ represents an angle between a surface of the lenticular lens and the support substrate.

4. A method of manufacturing a lenticular lens according to claim 1, wherein following the inkjet filling in the step (1), the exposure with ultraviolet light of (2) is performed on the same filling stage immediately after the inkjet filling.

5. A lenticular lens sheet obtained by using the method according to claim 1.

6. An optical element, comprising the lenticular lens sheet according to claim

7. A stereoscopic display, comprising the lenticular sheet according to claim

8. A lenticular lens sheet obtained by using the method according to claim

9. A lenticular lens sheet obtained by using, the method according to claim 3.

10. A lenticular lens sheet obtained by using the method according to claim 4.

11. An optical element, comprising the lenticular lens sheet according to claim 8.

12. An optical element, comprising the lenticular lens sheet according to claim 9.

13. An optical element, comprising the lenticular lens sheet according to claim 10.

14. A stereoscopic display, comprising the lenticular sheet according to claim 8.

15. A stereoscopic display, comprising the lenticular sheet according to claim 9.

16. A stereoscopic display, comprising the lenticular sheet according to claim 10.
